(19) United States
(12) Patent Application Publication
(10) Pub. No.: US 2011/0223508 A1
(43) Pub. Date: Sep. 15, 2011

(54) PROTON EXCHANGE MEMBRANE (PEM) FUEL CELL

(76) Inventor: Philip Mark Arnold, Costa Mesa, CA (US)

(21) Appl. No.: 13/046,753

(22) Filed: Mar. 13, 2011

Related U.S. Application Data
(60) Provisional application No. 61/313,768, filed on Mar. 14, 2010.

(51) Int. Cl. H01M 8/24; H01M 8/10

(52) U.S. Cl. 429/452; 429/479; 429/492

(57) ABSTRACT

A device includes a circular shaped cathode plate, a circular shaped membrane plate; and a circular shaped anode plate. The membrane is disposed between the cathode plate and anode plate. A system provides a fuel cell including a first circular shaped separator plate attached with a circular shaped cathode plate. The cathode plate includes grooves on a lower portion. A circular shaped proton exchange membrane (PEM) plate having an upper portion attached with the lower portion of the cathode plate. A circular shaped anode plate is attached with a second circular shaped separator plate. The anode plate includes grooves on an upper portion. The PEM plate is disposed between the lower portion of the cathode plate and the upper portion of the anode plate.

This application claims priority from U.S. provisional patent application Ser. No. 61/313,768, filed on Mar. 15, 2010, which is incorporated by reference.

### BACKGROUND OF THE INVENTION

1. Field of the Invention

The present invention relates to hydrogen fuel cells, and in particular to an advanced proton exchange membrane or polymer electrolyte membrane (PEM) fuel cell apparatus and system.

2. Background Information

The present problems with fuel cell design is that they are too large for vehicles to package and efficiency is limited because the working membrane area can only be enlarged by a small amount due to the distance that the gases can travel across the membrane before losing too many electrons for the membrane to be efficient.

### BRIEF SUMMARY OF THE INVENTION

One embodiment of the invention provides a device including a circular shaped cathode plate, a circular shaped membrane plate; and a circular shaped anode plate. The membrane is disposed between the cathode plate and anode plate.

Another embodiment of the invention provides a fuel cell system including a first circular shaped separator plate attached with a circular shaped cathode plate. The cathode plate includes grooves on a lower portion. A circular shaped proton exchange membrane (PEM) plate having an upper portion attached with the lower portion of the cathode plate. A circular shaped anode plate is attached with a second circular shaped separator plate. The anode plate including grooves on an upper portion. The PEM plate is disposed between the lower portion of the cathode plate and the upper portion of the anode plate.

A further embodiment of the invention provides multi-cell fuel cell comprising: a plurality of fuel cells, each fuel cell comprising: a first circular shaped separator plate coupled with a circular shaped cathode plate, wherein the cathode plate including a plurality of recesses on a lower portion. A circular shaped proton exchange membrane (PEM) plate having an upper portion is coupled with the lower portion of the cathode plate. A circular shaped anode plate is coupled with a second circular shaped separator plate, wherein the anode plate including a plurality of grooves on an upper portion. The PEM plate is disposed between the lower portion of the cathode plate and the upper portion of the anode plate.

Other aspects and advantages of the present invention will become apparent from the following detailed description, which, when taken in conjunction with the drawings, illustrate by way of example the principles of the invention.

### BRIEF DESCRIPTION OF THE SEVERAL VIEWS OF THE DRAWINGS

For a fuller understanding of the nature and advantages of the invention, as well as a preferred mode of use, reference should be made to the following detailed description read in conjunction with the accompanying drawings, in which:

FIG. 1A illustrates a square type design for a membrane;

FIG. 1B illustrates a conical/round PEM membrane design according to one embodiment of the invention;

FIG. 2 illustrates a prior art fuel cell;

FIG. 3 illustrates an exploded view of a conical/round designed PEM according to one embodiment of the invention;

FIG. 4 illustrates an exploded view of a conical/round fuel cell including a separator/insulator, cathode, PME and anode according to one embodiment of the invention;

FIG. 5A illustrates an exploded view of formation of the conical/round fuel cell according to one embodiment of the invention;

FIG. 5B illustrates a partial combination of the components illustrated in FIG. 5A according to one embodiment of the invention;

FIG. 5C illustrates a fuel cell formed from the components shown in FIG. 5A according to one embodiment of the invention;

FIG. 6 illustrates gas flow and reaction of the fuel cell shown in FIG. 4 according to one embodiment of the invention;

FIG. 7 shows a comparison of efficiency for known fuel cells; and

FIG. 8 shows a graph showing need for different types of fuel based on availability of oil and gas versus threat to climate change.

### DETAILED DESCRIPTION

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification, as well as meanings understood by those skilled in the art and/or as defined in dictionaries, treatises, etc. The description may disclose several preferred embodiments for content presentation, as well as operation and/or component parts thereof. While the following description will be described in terms of content presentation systems and processes for clarity and placing the invention in context, it should be kept in mind that the teachings herein may have broad application to all types of systems, devices and applications.

An embodiment of the invention provides a device including a circular shaped cathode plate, a circular shaped membrane plate; and a circular shaped anode plate. The membrane is disposed between the cathode plate and anode plate.

In one embodiment, the circular and conical shape of the PEM plate, anode plate and cathode plate reduce the footprint as compared to prior art fuel cells, reduces the travel for the chemical reaction via the working area of the PEM plate, which increases efficiency and reduces material costs.

In one embodiment of the invention the membrane for a fuel cell has a circular shape that is stretched down to form a cone. In this embodiment of the invention, the area of the membrane doubles that of the prior art square shaped membrane. Another advantage of the embodiments of the invention is that each cell is self hydrating and has less distance for fuel gases to travel than prior art designs, thus making each cell more efficient as compared to prior art square shaped cell designs.

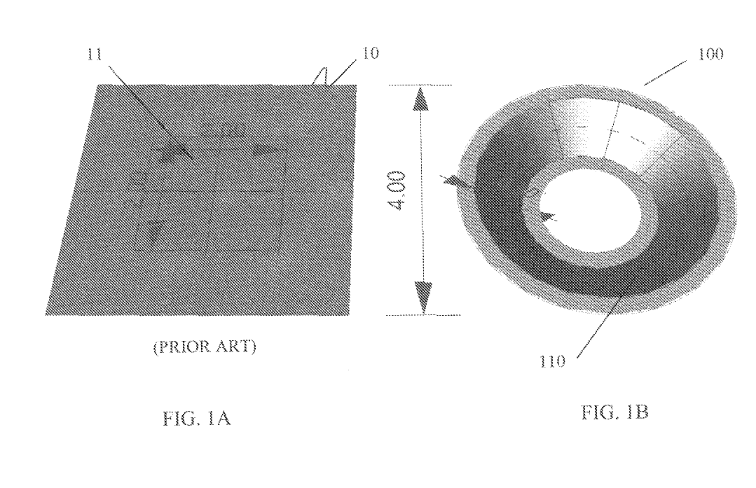

FIG. 1A shows a prior art square shaped membrane 10 design for a PEM fuel cell. FIG. 1B illustrates a round and conical design membrane 100 where the working area 110 of the membrane having a reduction in the distance that the gases travel across the working area 110 as compared to the square shaped membrane 10. It should be noted in the square design membrane 10 the working area 11 is 4 square inches and in the round and conical PEM 100, the working area 110 has an area of approximately 8 square inches. In one example, the increased area of the working area 110 over the prior art working area 11 is increased by approximately two times.

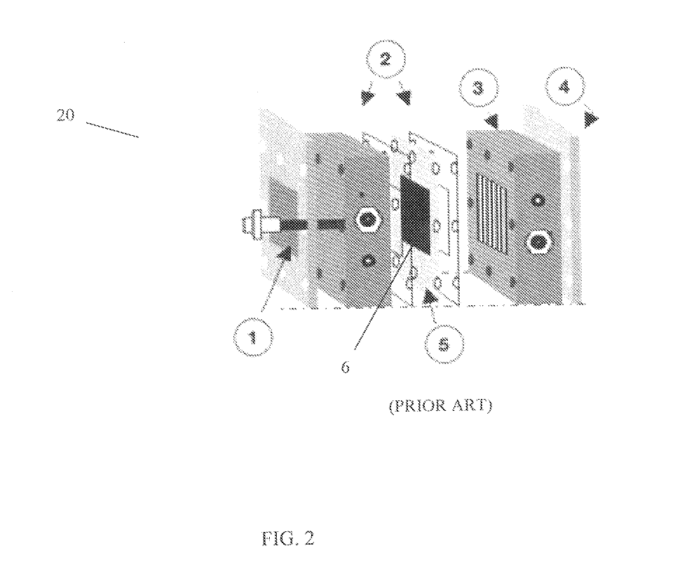

FIG. 2 illustrates a prior art fuel cell 20. Fuel cell 20 includes a silicon heater 1, precision gaskets 2, a graphite separator plate 3, a current collector plate 4 and PEM electrode assembly 5. In the center of the PEM 5 is the working area 6 of the membrane. The graphite separator plate 3 delivers the gases to each side of the PEM 5 so the reaction can take place. It should be noted that the silicon heater 1, precision gaskets 2 and current collector plate 4 are not required in the round and conical shaped membrane 100 as these parts are incorporated into the Separator/insulator.

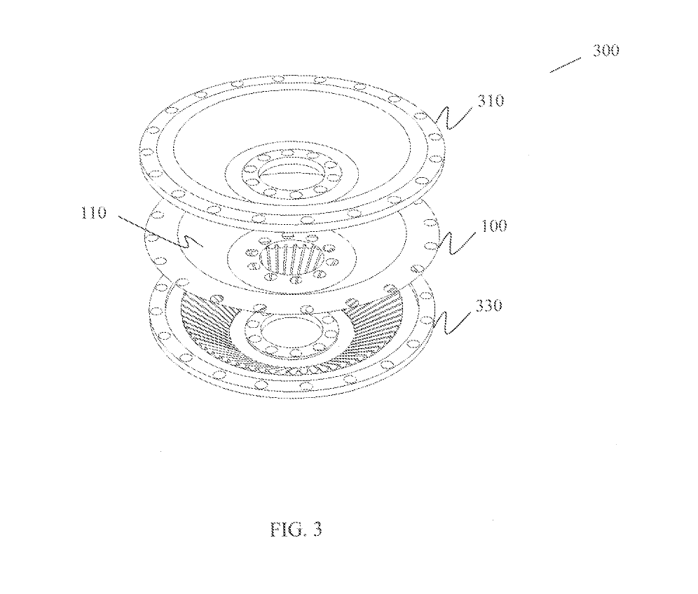

FIG. 3 illustrates an exploded view of a portion of a hydrogen fuel cell 300. For the round and conical PEM 100, the working area 110 has about double the area of the prior art PEM square design, and the gas needs to travel about half the distance across the PEM 100 as compared to the prior art. It should be noted that with less distance for the gas to travel there will be less dilution of electrons and protons to split, thus the reaction is more efficient than prior art designs. Graphite plates 310 and 330 are the portions of the fuel cell that deliver the gases so the chemical reaction can start. Graphite plates 310 and 330 will also deliver the produced electricity for use. Graphite plate 330 is the hydrogen side and graphite plate 310 is the oxygen side of the PEM 100.

In prior art fuel cell designs size is limited due to electron and proton dilution from the fuel (hydrogen) over the distance traveled across the working membrane area. In one embodiment of the invention, the PEM 100 reduces the distance traveled across the working membrane area 110, and also reduces the actual size footprint of a fuel cell. Therefore, in this embodiment of the invention, the because efficiency is increased with the reduction in size, less exotic materials are needed, which reduces the overall cost as compared to prior art PEM fuel cells.

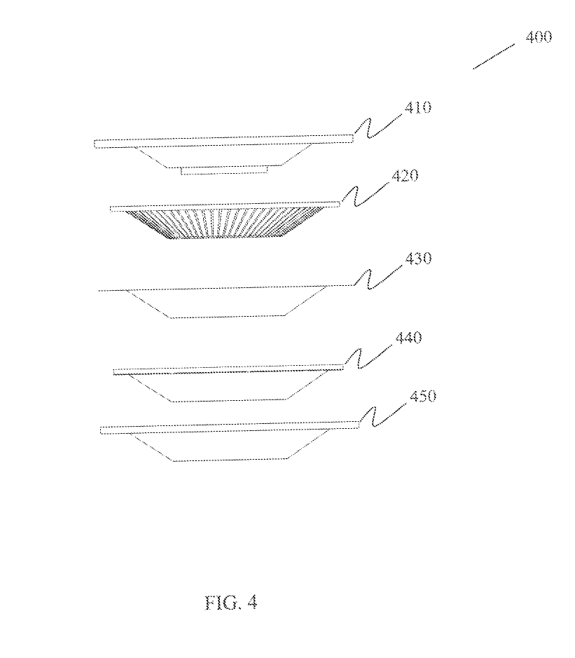

FIG. 4 illustrates an exploded view of a PEM fuel cell 400 according to one embodiment of the invention. As illustrated, the fuel cell 400 includes four types of main parts, which are the PEM 430, the cathode 420, the anode 440, first separator or insulator 410 and second separator or insulator 450. As illustrated, the components of fuel cell 400 have a round and conical shape with a horizontal orientation. In one embodiment of the invention the PEM 430 is sandwiched between the cathode 420 and the anode 440 forming one fuel cell where the separators 410 and 450 form separation or insulation between each fuel cell in a multi-fuel cell stack.

In one example, the circular and conical components increases the working area of the PEM 430 and reduces the distance that the gases need to travel as illustrated by a comparison of the prior art design shown in FIG. 1A to an embodiment of the invention shown in FIG. 1B. In one embodiment of the invention, water management is controlled so that the PEM 430 remains hydrated over the entire working area which provides increased efficiency over prior art PEM designs.

In one example, the cathode 420 and the anode 440 are made of graphite and include recesses or grooves on one side of each part that faces or is adjacent to each side of the PEM 430. These recesses or grooves are the delivery and recovery system for the fuel (hydrogen) and the gas (oxygen) to each side of the PEM 430 and are also used to drain of the water in a controlled way.

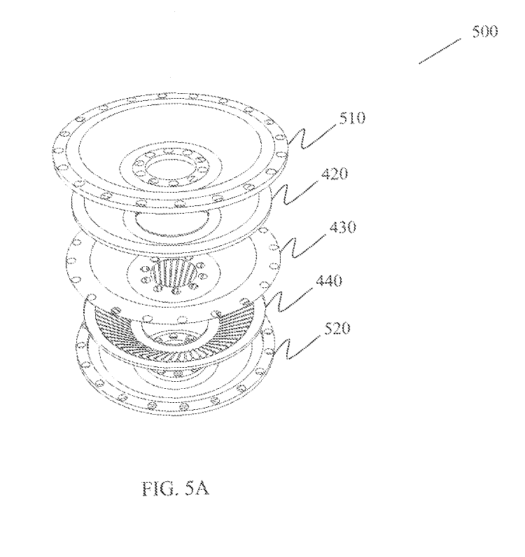

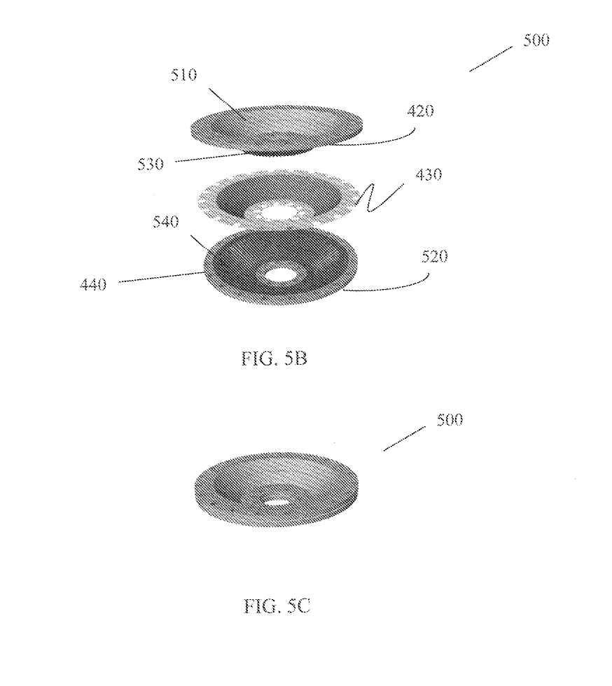

FIG. 5A-C illustrates the formation of a fuel cell 500 according to one embodiment of the invention. In one example, fuel cell 500 includes insulators 510 and 520 that may be made of a molded plastic or similar material, and encase the outside of the cathode 420 and the anode 440 so just the recesses are exposed on one side of the cathode 420 and anode 440. This insulator or case portions 510 and 520 accommodates the ducts for gas flow and the terminals for the electrical energy to be transferred as desired by a user for powering a device.

As illustrated in FIG. 5A the fuel cell 500 includes insulators 510 and 520, the cathode 420 and anode 440, and the PEM 430. FIG. 5B shows the insulator 510 attached with the cathode 420, and the insulator 520 attached with the anode 440. As shown, the recesses or grooves 530 are exposed on one side of the cathode 420 when attached with the insulator 510, and the recesses or grooves 540 are exposed on one side of the anode 440 when attached with the insulator 520. FIG. 5C shows the fuel cell 500 as formed from coupling the components shown in FIG. 5B together.

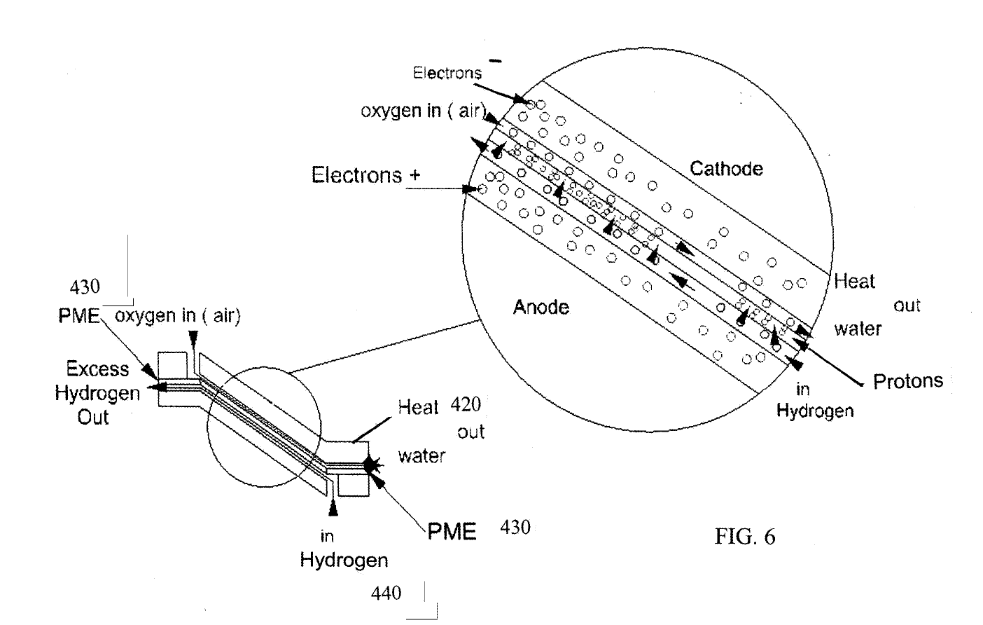

FIG. 6 shows the gases being delivered into the fuel cell system and shows the chemical reaction that takes place between the cathode 420 and anode 440. Hydrogen gas enters on the lower inside of the PME 430 exposing the gas to the working area 110 and then exiting on the lower outside of the PEM 430. Oxygen enters the upper outside of PEM 430 exposing this gas to the working area 110 and exits the upper inside of the PEM 430. With these gases on each side of the working area 110 the chemical reaction can take place to produce electrical energy. In one example, the PEM 430 working area 110 allows an electron and proton to be split from the hydrogen fuel. Since the electrons can not pass through the PEM 430, the electrons must travel through a circuit formed from the anode 440 to the cathode 420, thus providing electrical power. The proton can pass through the PEM 430 and recombine with the returning electron, where water and heat waste products are produced. The water migrates down across the PEM 430 hydrating and removing the heat all in the same operation.

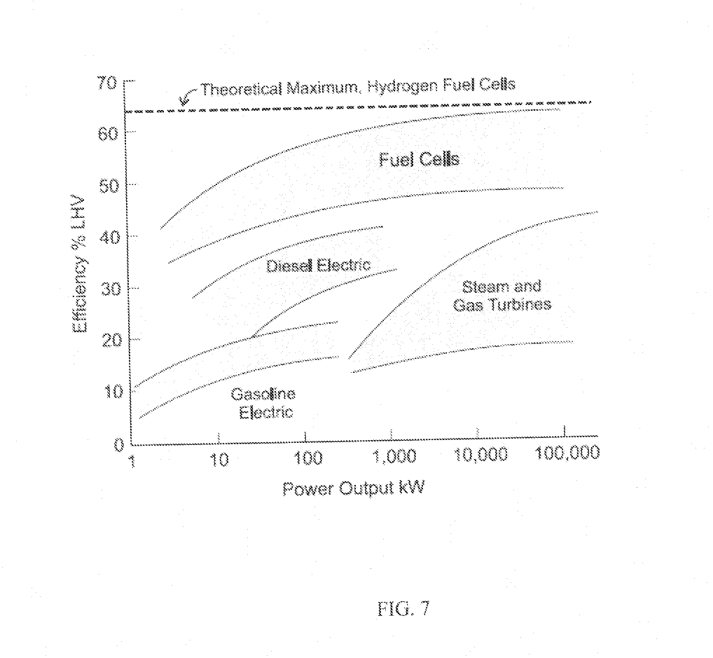

FIG. 7 shows an example of projected impact on current energy problems and benefits to an electric market. There are a variety of energy generation devices and technologies in existence. Hydrogen fuel cells provide a way to convert the hydrogen fuel's chemical energy directly into electricity in a device without moving parts. Hydrogen fuel cells remove the intermediate step of combustion that other fuels require to produce heat. The hydrogen fuel cell increases energy efficiency by a large margin and virtually eliminates air pollution. As shown in FIG. 7, fuel cells are superior to more traditional means of energy generation as far as efficiency and power output.

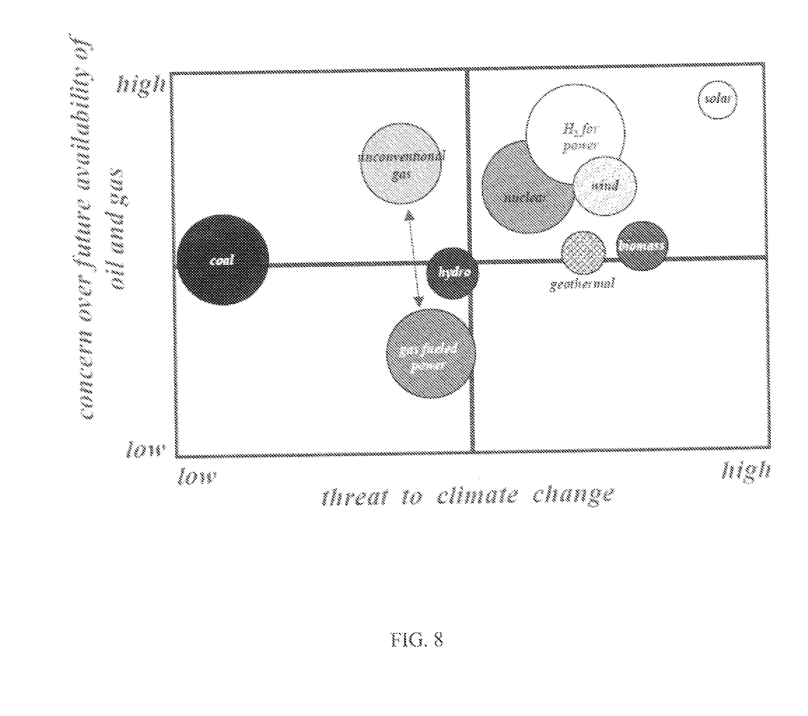

FIG. 8 shows the placement of hydrogen fuel as an optimal long-term power/energy option for the future that is not impacted by oil/gas supply, and posing little threat to adverse climate change.

In one example, the reduction in size of the fuel cell of the embodiments of the invention and reduction in material costs may provide for installation of fuel cells in homes across the USA, which in turn may lower the draw on the power grids. This may result in less greenhouse gases from power stations across the country. Additionally, since the size of the fuel cell embodiments is reduced, more fuel cells may be combined for greater power output with the size reduction. Based on the reduced size of the fuel cell embodiments of the invention, more applications for the various embodiments of the invention may arise, such as portable units for powering devices in areas isolated from conventional power sources or power outlets.

In one example, fuel cells 400/500 may be reduced further in size or increased in size for different power requirements. Additionally, the size of the conical angle may be increased or decreased to adjust the working area 110 as desired. Other components may be added to the fuel cell embodiments for various purposes, such as processors and memory for determining optimum efficiency, controlling chemical reaction rates, starting and stopping reactions, controlling gas intake, measuring various metrics, transmitting various metrics (e.g., output, efficiency, input, trends, historical information, etc.).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. An apparatus comprising:
a circular shaped cathode plate;
a circular shaped membrane plate; and
a circular shaped anode plate,
wherein the membrane is disposed between the cathode plate and anode plate.

2. The apparatus of claim 1, wherein membrane plate comprises a proton exchange membrane (PEM) plate.

3. The apparatus of claim 2, wherein the cathode plate, PEM plate and anode plate form a self-hydrating hydrogen fuel cell.

4. The apparatus of claim 2, wherein the PEM plate includes a conical shaped working area configured for processing a chemical reaction with oxygen and hydrogen.

5. The apparatus of claim 2, further comprising a first insulator plate and a second insulator plate.

6. The apparatus of claim 5, wherein the cathode plate is coupled to the first separator plate and the anode plate is coupled to the second separator plate.

7. The apparatus of claim 6, wherein the first separator plate, the cathode plate, the PEM plate, the anode plate and the second separator plate are coupled together forming a fuel cell.

8. The apparatus of claim 6, wherein one side of the cathode plate and one side of the anode plate include formed recesses.

9. The apparatus of claim 6, wherein the recesses deliver and recover hydrogen and oxygen to each side of the PEM plate and drain water in a controlled way.

10. The apparatus of claim 7, wherein the fuel cell produces electricity.

11. The apparatus of claim 7, further comprising at least two fuel cells coupled to one another forming a multi-cell fuel cell.

12. A fuel cell system comprising:
a fuel cell comprising:
a first circular shaped separator plate coupled with a circular shaped cathode plate, wherein the cathode plate including grooves on a lower portion;
a circular shaped proton exchange membrane (PEM) plate having an upper portion coupled with the lower portion of the cathode plate; and
a circular shaped anode plate coupled with a second circular shaped separator plate, wherein the anode plate including grooves on an upper portion,
wherein the PEM plate is disposed between the lower portion of the cathode plate and the upper portion of the anode plate.

13. The system of claim 12, further comprising a plurality of fuel cells coupled to one another forming a multi-cell fuel cell.

14. The system of claim 12, wherein the fuel cell comprises a self-hydrating hydrogen fuel cell.

15. The system of claim 14, wherein the PEM plate includes a conical shaped working area configured for processing a chemical reaction with oxygen gas and hydrogen gas for producing electrical energy.

16. The system of claim 6, wherein the recesses deliver and recover hydrogen and oxygen to each side of the PEM plate and drain water in a controlled way.

17. A multi-cell fuel cell comprising:
a plurality of fuel cells, each fuel cell comprising:
a first circular shaped separator plate coupled with a circular shaped cathode plate, wherein the cathode plate including a plurality of recesses on a lower portion;
a circular shaped proton exchange membrane (PEM) plate having an upper portion coupled with the lower portion of the cathode plate; and
a circular shaped anode plate coupled with a second circular shaped separator plate, wherein the anode plate including a plurality of grooves on an upper portion,
wherein the PEM plate is disposed between the lower portion of the cathode plate and the upper portion of the anode plate.

18. The multi-cell fuel cell of claim 17, wherein each fuel cell comprises a self-hydrating hydrogen fuel cell.

19. The multi-cell fuel cell of claim 18, wherein the PEM plate includes a conical shaped working area configured for processing a chemical reaction with oxygen and hydrogen for producing electrical energy, heat and water.

20. The multi-cell fuel cell of claim 19, wherein the recesses deliver and recover hydrogen and oxygen to each side of the PEM plate and drain water in a controlled way.
